(19) United States
(12) Patent Application Publication
(10) Pub. No.: US 2023/0351501 A1
(43) Pub. Date: Nov. 2, 2023

(54) CURRENCY EXCHANGE MANAGEMENT COMPUTER, FOREIGN CURRENCY EXCHANGE SYSTEM, AND METHOD THEREFOR

(71) Applicant: Seong Min YOON, Guri-si (KR)

(72) Inventor: Seong Min YOON, Guri-si (KR)

(21) Appl. No.: 17/922,620

(22) PCT Filed: Apr. 29, 2021
(86) PCT No.: PCT/KR2021/005412

§ 371 Date: Nov. 1, 2022

(30) Foreign Application Priority Data
May 4, 2020 (KR) 10-2020-0053160

(51) Int. Cl. G06Q 40/04; G06Q 20/40

(52) U.S. Cl. CPC G06Q 40/04; G06Q 20/4014

(57) ABSTRACT

A foreign exchange system includes: an identity authentication means for performing identity authentication, such as user authentication for opening an online account and exchanging, on the basis of identity authentication information of a user who has requested the user authentication, based on consistency with related person including acquaintances and related data collected by the means itself; a dedicated account generation means for opening and managing, in connection with financial information of the user, an online dedicated account for each country of the user whose user authentication has been completed; and an exchange management means for, when applying for exchange using the opened online dedicated account for each country of the user, performing an exchange process after the number of countries for which exchange approval has been set and the set number of non-related persons not related to the user verify the validity of the exchange application.

### BACKGROUND OF THE INVENTION

### Field of the Invention

The present invention relates to an exchange management computer, a foreign currency exchange system and a method therefor. More particularly, the present invention relates to a computer, a system and method for an exchange management, which authenticate the user's identity through the user's identity authentication information by related persons including the user's acquaintances in order to open an online dedicated account, which is uniquely identifiable information, by a user who wants to exchange the currency of a specific country into the currency of another country online, perform the exchange transaction approval of the user by a predetermined number of non-related persons who are not related to the user, and perform the currency exchange automatically by the ledger sharing method by applying the ‘basic exchange rate’ at the time of the user's request for currency exchange, when exchanging money using the online dedicated account without using an existing intermediary, wherein the predetermined number of non-related persons selects a predetermined number of countries including the countries to be exchanged except for a country to which the user belongs, and is extracted from the selected countries.

### Description of Related Art

For foreign exchange, it is common to exchange a specific currency in the user's possession or in a bank account into the currency of the desired country by applying the exchange rate at the time at the bank. This traditional exchange method requires excessive exchange fees, and different basic exchange rates are set excessively depending on the purpose of exchange, so money loss occurs to the money changer and takes a lot of time for exchange.

In order to solve the problems of this exchange method, an online exchange method was studied.

The invention of a foreign exchange brokerage service method through internet in Korean Patent Publication No. 10-2001-0110071 (published date: Dec. 12, 2001) is disclosed.

The disclosed invention is a foreign exchange brokerage service method including creating a customer account to record the customer's foreign exchange reserves and notifying the customer account number to the customer's terminal; posting the transaction request information sent from the customer terminal; investigating whether any of the previously posted transaction request details satisfy the transaction execution condition; concluding a transaction between the two customers if any of them satisfy the transaction execution conditions; and performing actual transfer of the transaction amount through the customer's bank account, and reflecting the transaction execution details in the customer's account.

Although the disclosed invention has the convenience of being able to use online for foreign exchange, problems may arise in user authentication and approval of exchange for online exchange.

In addition, the invention of a method for intermediation of foreign exchange dealings through the medium of digital assets based on block-chain technology including crypto currency in Korean Patent Publication No. 10-2019-0091211 (published on Aug. 5, 2019) is disclosed.

The disclosed invention, when a block chain-based digital asset containing one crypto currency is traded in two or more currencies within one crypto currency exchange, exchanges that trade in different currencies share the digital assets through contracts, or exchanges that trade in different currencies share information about the digital asset transaction, comprises: a) receiving, by the exchange transaction brokerage server, with respect to the block chain-based digital asset, information on a bid-ask price and standby balance traded based on currency A from the block chain-based digital asset transaction server based on currency A; b) receiving, by the exchange transaction brokerage server, with respect to the block chain-based digital asset, information on a bid-ask price and standby balance traded based on currency B from the block chain-based digital asset transaction server based on currency B; c) calculating, by the exchange transaction brokerage server, the foreign exchange bid price and waiting balance based on currency A or the foreign exchange ask price and waiting balance based on currency Bin consideration of the asking price and waiting balance of the block chain-based digital asset based on currency A and the asking price and waiting balance of the block chain-based digital asset based on currency B; d) calculating, by the exchange transaction brokerage server, the foreign exchange asking price and waiting balance based on currency A or the foreign exchange bid price and waiting balance based on currency Bin consideration of the asking price and waiting balance of the block chain-based digital asset based on currency A and the bid price and waiting balance of the block chain-based digital asset based on currency B.

The disclosed invention has problems in which the complexity of converting a specific currency into a crypto currency and converting the crypto currency into the desired currency, whether or not there is safety related to the approval of the exchange application by the foreign exchange brokerage server leading the exchange, overload of the system caused by having to share the ledger to all nodes participating in the network, excessive time required for block generation, and difficulty in simultaneous exchange processing of large-scale transactions.

There are needs for an invention in which performing foreign exchange using the user's online dedicated account, in order to prevent misuse and errors, the user's user authentication for opening the online dedicated account is performed based on the determination of consistency between the relationship data analyzed based on the user's own identity authentication information by related persons including acquaintances and the relationship data collected by itself, when a user applies for foreign currency exchange using the online dedicated account opened, whether or not to approve the exchange is performed based on a decision made by non-related persons who are not related to the selected user in a predetermined number of countries including or excluding the country to which the user belongs, and in order to secure the safety and speed of exchange, the information on the approval details of the exchange application is stored, in a distributive manner, in the foreign exchange system, the user terminal of the exchange applicant, the non-related person terminals of the approved participants, or the cloud computing system linked to the user and the approved participants.

### SUMMARY OF THE INVENTION

The present invention is conceived to solve the problems of the related art, and an object of the present invention provides a computer, a system and method for an exchange management, in which performing the exchange using the user's online dedicated account, in order to prevent misuse and errors, the user's user authentication for opening the online dedicated account is performed based on the determination of consistency between the relationship data analyzed based on the user's own identity authentication information by related persons including acquaintances and the relationship data collected by itself, when a user applies for foreign currency exchange using the online dedicated account opened, whether or not to approve the exchange is performed based on a decision made by non-related persons who are not related to the user in a predetermined number of countries including or excluding the country to which the user belongs, and in order to secure the safety and speed of exchange, the information on the approval details of the exchange application is stored, in a distributive manner, in the foreign exchange system, the user terminal of the exchange applicant, the non-related person terminals of the approved participants, or the cloud computing system linked to the user and the approved participants.

As a technical solution for achieving the technical object of the present invention, a first aspect of the present invention presents computer for exchange management that receives an exchange application of user and exchanges the user's currency into another country's currency comprising: at least one hardware processor and a memory storing a program for performing currency exchange that causes the computer to perform: receiving, by the at least one hardware processor of the computer, an exchange application entered into an online dedicated account for each country by a user who wants to exchange the user's currency into another country's currency; selecting, by the at least one hardware processor of the computer, a predetermined number of countries to participate in whether or not to approve the exchange application of the user; and performing, by the at least one hardware processor of the computer, exchange of the user's currency into the currency of another country based on verification of the validity of the exchange application by the approval participants made up of a predetermined number of non-related persons selected in the selected countries.

According to a second of the present invention, a system for foreign currency exchange comprising: a foreign currency exchange system section includes an identity authentication system which performs user authentication of the user who applied for online dedicated account through the determination of consistency between relationship data indicating a specific relationship between people analyzed based on an identity verification of the user by a predetermined number of related persons related to the user and relational data indicating a specific relationship between people, which is collected and stored in the system itself; an account generation system which generates and manages an online dedicated account for each country applied by a user whose the user authentication is verified in the identity authentication system; and an exchange management system which performs the exchange based on a decision made by non-related persons who are not related to the user in a predetermined number of countries including or excluding the country to which the user belongs and manages profit information given to participants in the exchange process and information on approval details or transaction information for exchange applications, user terminal which is connected to communication with the foreign currency exchange system and is used by the users of each country and provides information about the related person who participates in identity authentication for user authentication, requests for opening of an online dedicated account, exchanges using an online dedicated account, stores profit information granted in accordance with the exchange, stores information sharing approval details of exchange application, and uses the exchanged foreign currency, and at least one cloud computer which stores the shared information of the approval details of the currency exchange application is stored in connection with the online dedicated account information of the user for each country in the storage capacity given to the user of the user terminal for each country.

According to a third of the present invention, a method for foreign currency exchange management comprising: outputting or executing, by a user terminal, a user interface for performing the currency exchange by connecting to the foreign currency exchange system; transmitting, by the user terminal, a user information and related person information such as acquaintances for performing the user authentication input into the user interface to the identity authentication system of the foreign currency exchange system; extracting, by the identity authentication system, identity authentication information regarding the identity of the user who requested a user authentication using the related person information and the big data collected by the identity authentication system, performing the user authentication of the user, and transmitting the user authentication information to the user terminal; transmitting, by the user terminal, the user's financial institution account information, setting and application information of the online dedicated account input into the user interface to the dedicated account generation system of the foreign currency exchange system; generating and storing, by the account generation system, when there is no problem in the setting information of the online dedicated account of the user by checking the user authentication of the user who applied for the online dedicated account opening, an online dedicated account of the user in connection with the financial institution account information of the user, and transmitting the generated online dedicated account information to the user terminal; transmitting, by the user terminal, an exchange application information input in the user interface to the exchange management system of the foreign currency exchange system; receiving, by the exchange management system, an exchange application of the user, selecting a predetermined number of countries including or excluding the user's country, and selecting a predetermined number of non-related persons not related to the user from the selected countries as approval participants of the exchange application; requesting, the exchange management system, a verification of the validity of exchange amount by providing the exchange application information of the user and a basic exchange rate information at the time of exchange to the non-related person terminals of the approval participants in each country, and receiving a verification information of the validity of the exchange amount provided by the approval participants; performing, by the exchange management system, exchange processing of the amount corresponding to the exchange application of the user based on the verification information of the validity of the exchange amount received from the approval participants, and inputting and storing the exchange amount information into the online dedicated account; storing, in a distributive manner, by the exchange management computer, information on the approval details of the exchange application of the user to the system, the user terminal of the exchange requester and the non-related person terminal of the approval participants, or the connected cloud computing system; and storing, by the exchange management computer, a profit information set in relation to the exchange application and approval participation in the user terminal of the exchange applicant and the non-related person terminals of the approval participants, or in the cloud computing system associated with the user and the approval participants.

### Advantageous Effects

According to the present invention, performing user authentication of the user who applied for online dedicated account through the determination of consistency between relationship data indicating a specific relationship between people analyzed based on an identity verification of the user by a predetermined number of related persons related to the user and relational data indicating a specific relationship between people, which is collected and stored in the system itself, generating an online dedicated account for each country applied by a user whose the user authentication is verified, performing the exchange based on a decision made by non-related persons who are not related to the user in a predetermined number of countries including or excluding the country to which the user belongs; and it is possible to secure the safety and speed of currency exchange by storing, in a distributive manner, information on the approval details of the exchange application of the user to the system, the user terminal of the exchange requester and the non-related person terminal of the approval participants, or the connected cloud computing system.

### BRIEF DESCRIPTION OF THE DRAWINGS

FIG. 1 is a schematic diagram illustrating an exemplary embodiment of the foreign currency exchange system of the present invention.

FIG. 2 is a schematic diagram illustrating an exemplary embodiment of the identity authentication system, which is the main part of the foreign currency exchange system of the present invention.

FIG. 3 is a schematic diagram illustrating an exemplary embodiment of the account generation system, which is the main part of the foreign currency exchange system of the present invention.

FIG. 4 is a schematic diagram illustrating an exemplary embodiment of the exchange management system, which is the main part of the foreign currency exchange system of the present invention.

FIG. 5 is a flowchart illustrating an exemplary embodiment of a method for foreign currency exchange of the present invention.

### BEST MODE FOR IMPLEMENTATION OF THE INVENTION

As the best mode for carrying out the present invention, a computer for exchange management that receives the user's application for currency exchange and converts the user's currency into another country's currency comprising: at least one hardware processor and a memory storing a program for performing currency exchange that causes the computer to perform: receiving a currency exchange request entered into an online dedicated account for each country by a user who wants to exchange the user's currency into another country's currency; selecting a predetermined number of countries to participate in whether or not to approve the currency exchange request of the user, and performing the exchange of the user's currency into the currency of another country based on verification of the validity of the currency exchange request by the approval participants made up of a predetermined number of non-related persons selected in the countries.

### Detailed Description of the Preferred Embodiment

Hereinafter, an embodiment of the exchange management computer, foreign currency exchange management system and method of the present invention will be described in detail with reference to the accompanying drawings. Terms used in the description of the embodiments of the present invention will be defined.

For convenience of description of the exemplary embodiment of the present invention, among terms used in the description of the exemplary embodiment of the present invention, the configuration of hardware itself may be referred in the configurations of the invention, and further, a configuration of a web program or a computer program executed by utilizing the hardware resource may be referred. For example, an exchange management computer among the configurations of the present invention may be computer hardware itself, and may be a web program or a computer program executed by utilizing a hardware source of a computer.

Preferably, the various computers including the identity authentication computer, the account generation computer and the exchange management computer used in the embodiment of the present invention include at least one hardware processor and a memory storing a program as a component for performing the embodiment of the present invention. It is preferable that the at least one processor controls the execution of the program stored in the memory. In addition, the programs stored in the memory of the various computers are composed of a plurality of components for performing an embodiment of the present invention, and the components may be expressed as “˜part”, “˜module” or “˜unit”.

In addition, “˜system” and “˜systems” used in the description of the present invention mean components including one or more components of a computer or terminal. However, it is not limited to that term.

In addition, the ‘user interface’ described in the embodiment of the present invention may be a web program or an application program that is output or installed on a user terminal or a non-related terminal and executed.

In addition, the meanings of identity authentication, other countries, acquaintances, related persons, and non-related persons used in the embodiments of the present invention may be defined in the description of the embodiments below.

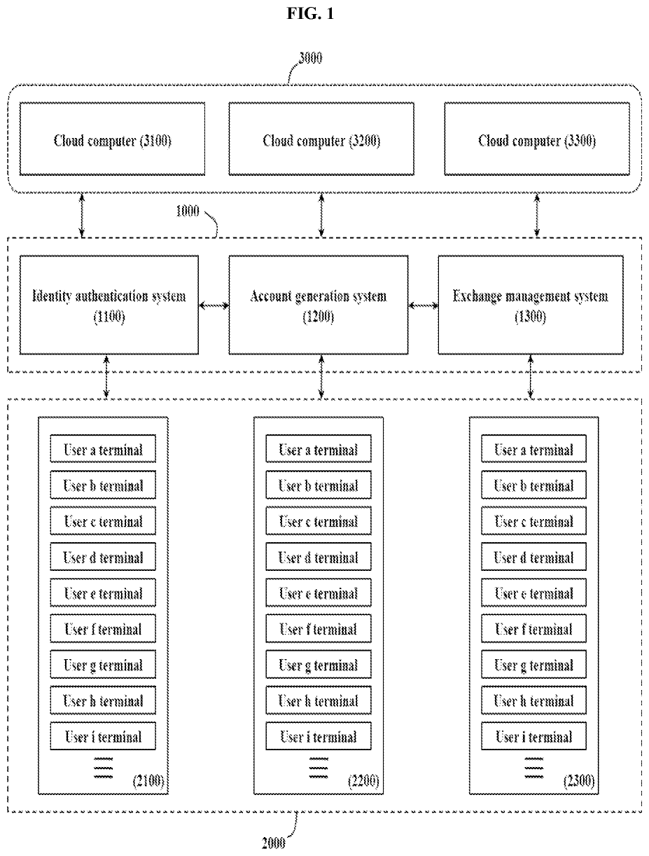

FIG. 1 is a schematic diagram illustrating an exemplary embodiment of the foreign currency exchange management system of the present invention.

As illustrated in FIG. 1, the system for foreign currency exchange of the present invention includes a foreign currency exchange management system section 1000 including: an identity authentication system 1100 which performs user authentication of the user who applied for online dedicated account through the determination of consistency between relationship data indicating a specific relationship between people analyzed based on an identity verification of the user by a predetermined number of related persons related to the user and relational data indicating a specific relationship between people, which is collected and stored in the system itself; an account generation system 1200 which generates and manages an online dedicated account for each country applied by a user whose the user authentication is verified in the identity authentication system 1100; and an exchange management system 1300 which performs the exchange based on a decision made by non-related persons who are not related to the user in a predetermined number of countries including or excluding the country to which the user belongs and manages profit information given to participants in the exchange process and information on approval details or transaction information for exchange applications, member terminal section 2000 of each country includes user terminals 2100, 2200 and 2300 of the users for each country which are connected to communication with the foreign currency exchange system section 1000 and execute the user interface, and provide information about the related person who participates in identity authentication for user authentication, request for opening of an online dedicated account, exchange using an online dedicated account, store profit information granted in accordance with the exchange, store information sharing approval details of exchange application, and use the exchanged foreign currency; related person terminals 2100, 2200 and 2300 for each country used by the related persons of the user who participate in the user's user authentication and perform identity verification; and non-related person terminals 2100, 2200 and 2300 used by the approval participants of each country participating in the approval of the user's exchange application, and a cloud computing system 3000 including, at least one cloud computer 3100, 3200, and 3300 which store the shared information of the approval details of the currency exchange application in the storage capacity given to the user of the user terminal for each country in connection with the online dedicated account information of the user for each country, and allow the stored shared information from the user terminals of each country, the non-related person terminals, and the foreign currency exchange system section 1000.

The user terminal of each country, the related person terminal, and the non-related person terminal may be a user terminal, a related person terminal, or a non-related person terminal according to the subject of each action. For example, when a non-related person terminal applies for exchange, the non-related person terminal becomes a user terminal and the user terminal may become a non-related person terminal. In addition, when the related person terminal requests user authentication, the related person terminal becomes a user terminal and the user terminal may become a related person terminal.

The cloud computing system 3000 may be configured as an integrated system 3000, and may also be configured with cloud computers 3100 to 3300 for each country. A storage space for use of the foreign exchange system may be provided in the cloud computing system 3000 or the cloud computers 3100 to 3300 of each country in connection with user information of each country. Thereby, the foreign exchange system section 1000 may provide the user's storage space information of the cloud computing system 3000 or the cloud computers 3100 to 3300 to the user terminals 2000 of each country.

Therefore, users of each country can utilize the storage space of the user terminal 2000 or the storage space of the cloud computing system 3000 that they use for various information related to the use of the foreign currency exchange system through the online dedicated account of the present invention.

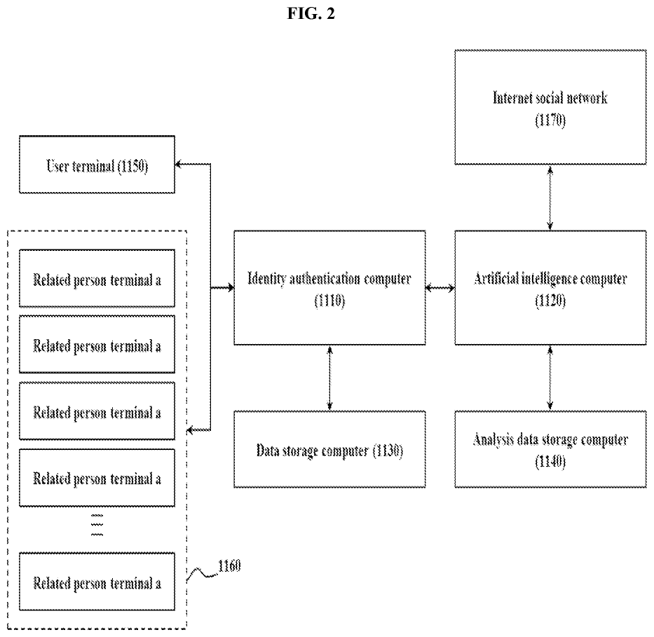

FIG. 2 is a schematic diagram illustrating an exemplary embodiment of the identity authentication system, which is the main part of the foreign currency exchange system of the present invention.

As illustrated in FIG. 2, the identity authentication of the present invention is the configuration including: an identity authentication computer 1110 which receives a request for user authentication from the user terminal, receives and manages information on a group of related persons and related persons around the authentication requester, and manages the generated user authentication information and identity verification information; an artificial intelligence computer 1120 for performing identity verification of the user by using a big data database generated by analyzing information collected through the internet social network 1170, etc. of information such as words used during daily conversations and conversations between acquaintances and data analyzed based on communication details information of a group of related persons, and transmitting the identity verification information to the identity authentication computer 1110; a data storage computer 1130 for storing a authentication requester information of the user authentication, a related person group information, a communication details information of the related person group managed by the identity verification computer 1110, and data including identity verification information transmitted from the artificial intelligence computer 1120; an analysis data storage computer 1140 includes information analyzed by the artificial intelligence computer 1120 based on the big data database collected and analyzed by the artificial intelligence computer 1120 and the communication details of the related person group received from the identity authentication computer 1110, various data analysis of the artificial intelligence computer 1120 and statistics based thereon; a user terminal 1150 of an authentication requester connected to the identity authentication computer 1110 and for outputting or executing a user interface for requesting user authentication and receiving and managing an approval information of user authentication; and at least one related person terminal 1160 that is communicatively connected to the identity authentication computer 1110 and for outputting or executing a user interface which provides information such as relationship information and communication details with the authentication requester of the user authentication to the identity authentication computer 1110 by related persons such as acquaintances who are related to the authentication requester.

The identity authentication computer 1110 may include at least one server computer having a communication means and capable of executing a computer program or a web program.

The artificial intelligence computer 1120 may include at least one server computer having a communication means and capable of executing an artificial intelligence (AI)-related computer program or web program.

The data storage computer 1130 and the analysis data storage computer 1140 may be configured as a database management system (DBMS).

The user terminal 1150 and the related person terminal 1160 are provided with a communication means, and may be configured of terminals such as a smartphone, a tablet computer, a personal computer (PC), a notebook computer in which an application program or a web program can be executed. The application program or web program provided in the user terminal 1150 may be configured as a user interface for requesting the approval of the user authentication to the identity authentication computer 1110. The application program or web program provided by the related person terminal 1160 may be configured as a user interface for identity verification that provides relationship information and communication details with the authentication requester of the user authentication to the identity authentication computer 1110.

The Internet social network 1170 is configured to include various social network services (SNS) and Internet media.

The present invention is characterized in that when the user terminal 1150 requests user authentication, the identity authentication computer 1110 receives information of related persons such as acquaintances of the authentication requester and communication information between the authentication requester and related persons from the authentication requester, receives relationship information and communication details information with the authentication requester from at least one related person terminal 1160 in order to verify that the authentication requester is the same person to the related persons, and requests identity verification by transmitting the received communication details information of the related persons to the artificial intelligence computer 1120. The artificial intelligence computer 1120 performs the identity verification of the user by using a big data database generated by analyzing information collected through the internet social network 1170, etc. of information such as words used during daily conversations and conversations between acquaintances and data analyzed based on communication details information of a group of related persons, and transmitting the identity verification information to the identity authentication computer 1110; and the identity authentication computer 1110 transmits identity authentication approval information to the user terminal 1150 based on the received identity verification information.

When the communication details information is voice information, it is possible to analyze the information using voice recognition technology, determine whether the voice matches, or use a voice text conversion technique, and the like.

The relationship information between the related persons and the authentication requester may include, for example, family members, relatives, friends, work colleagues, school classmates, social members, and acquaintances for hobby.

In addition, the communication details information of the related persons or group of related persons includes various types of communication information performed using a mobile phone, for example, such as a mobile phone text message (SMS, MMS, etc.), a chat message in a chatting application program running on a mobile phone, a text message on a social network service (SNS), e-mail letters, and Internet voice calls on mobile phones.

In the embodiment of the identity authentication system 1100 of the present invention, the function of the artificial intelligence computer 1120 is performed by the identity authentication computer 1110, and the artificial intelligence computer 1120 may be omitted.

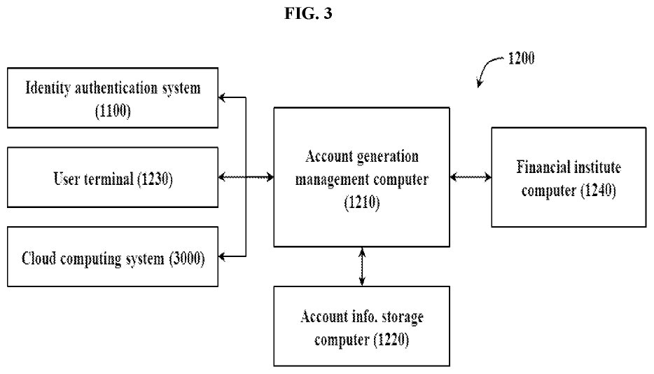

FIG. 3 is a schematic diagram illustrating an exemplary embodiment of the account generation system, which is the main part of the foreign currency exchange system of the present invention.

As illustrated in FIG. 3, the account generation system 1200 of the present invention includes an account generation management computer 1210 that is connected to the identity authentication system 1100 by means of communication, etc., and receives an online dedicated account setting information according to the application for opening an online dedicated account for each country of users who have been authenticated by the identity authentication system 1100, opens and stores the online dedicated account for each country of the user; an account information storage computer 1220 for storing user information, including online dedicated account information of users generated by the account generation management computer 1210; a user terminal 1230 that is communicatively connected to the account generation management computer 1210 and outputs or executes a user interface for inputting user information and financial account information to apply for opening an online dedicated account for each country; and a financial institution computer 1240 that is communicatively connected to the account generation management computer 1210, has financial information of the user, and provides or confirms the user's financial information to the account generation management computer 1210.

The user terminal 1230 transmits the setting information of the online dedicated account for each country input by the user into the user interface of the foreign currency exchange system executed in the user terminal to the account generation management computer 1210. The information of the online dedicated account for each country generated in the account generation management computer 1210 may be configured as, for example, “KR02123456789101112 1” including “country information, regional information, unique number, and using country information”. Table 1 below shows an example of the input setting information of the online dedicated account for each country.

TABLE 1

| Country | Regional | | Country | Reference (by |
|---|---|---|---|---|
| Information | Information | Unique Number | information of use | country) |
| KR | 02 | 123456789101112 | 1 | US(USD) |
| | | | 2 | EP(EUR) |
| | | | 3 | CN(CNY) |

Referring to Table 1 above, the online dedicated account opened by the user is based in Korea (KR) and Seoul (02), the account for US dollars is “KR02123456789101112 1”, and the account for Euros is “KR02123456789101112”2”, the account for Chinese Yuan (CNY) may be configured to include information such as “KR02123456789101112 3”.

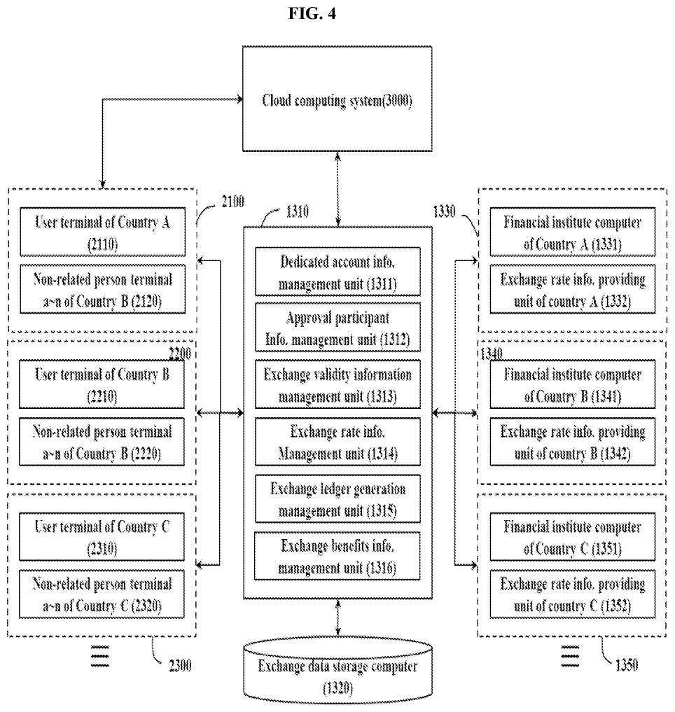

The account generation management computer 1210 simultaneously stores the online dedicated account information for each country opened to the user in the storage space of the user interface of the user terminal 1230 and the user's data storage space secured in the cloud computing system 3000, or may be stored in any one of them. FIG. 4 is a schematic diagram illustrating an exemplary embodiment of the exchange management system, which is the main part of the foreign currency exchange system of the present invention.

As illustrated in FIG. 4, the exchange management system 1300 of the present invention includes an exchange management computer 1310 which manages the exchange of the requested currency in response to the exchange request of the user who is the holder of the online dedicated account for each country; an exchange data storage computer 1320 which is included in the exchange management computer 1310 or is connected to a communication means and stores various data such as the online dedicated account of the user required for exchange, and exchange rates for each country; and financial institution systems 1230, 1240 and 1250 for each country which provide information including financial accounts of users in each country who requested exchange, financial information necessary for exchange, and exchange rate information to the exchange management computer 1310.

In addition, the exchange management system 1300 may further include a user groups 2100, 2200, and 2300 for each country which is communicatively connected to the exchange management computer 1310 including user terminals used by exchange requesters in each country and non-related person terminals used by at least one non-related person not related to the user requesting exchange; and a cloud computing system 3000 which is communicatively connected to the exchange management computer 1310 and the user groups 2100, 2200, 2300 for each country, and has a data storage space for the users for each country.

In addition, the exchange management computer 1310 includes dedicated account information management unit 1311 which manages user information of each country that has generated the online dedicated account in the account generation system 1200 and the generated online dedicated account information; an approval participant information management unit 1312 which manages information on countries connected to the foreign currency exchange system section 1000 for managing the selection of country to participate in whether or not to approve the exchange in relation to the exchange request of the user who requested the exchange and non-related persons of the country, and information of users who have generated the online dedicated account for each country; an exchange validity information management unit 1313 which generates and manages the validity information of the exchange request by integrating the exchange approval or rejection information of the predetermined number of countries and the predetermined number of participants selected by the approval participant information management unit 1312 for the exchange request; an exchange rate information management unit 1314 which collects and manages real-time exchange rate information provided by the financial institution systems 1330, 1340, and 1350 for each country; an exchange ledger generation management unit 1315 which generates the exchange information of the user who made the exchange and the exchange approval details of the countries and participants participating in the decision-making on whether to approve the exchange request as an exchange ledger, stores the generated exchange ledger in the exchange data storage computer 1320, and stores, in a distributive manner, in the user terminal of the exchange requester and non-related person terminals, which are a predetermined number of participants among the participants who participated in the approval of the exchange application; and an exchange profit information management unit 1316 which grants points or provides a certain profit in proportion to the number of approvals or approval amount of the approval participants who participated in the approval of the exchange application, and stores and manages the data in connection with the people involved in the exchange.

The financial institution systems 1330, 1340, and 1350 for each country are configured as an example of country A among countries linked to the foreign currency exchange system, a country A financial institution computer 1331 having a user's financial account and financial information in country A and performing financial transactions with the user and a country A exchange rate information providing unit 1232 for providing real-time an exchange rate information to the exchange management computer 1210. The country A exchange rate information providing unit 1332 may be configured as a separate computer or included in the country A financial institution computer 1331.

The user groups 2100, 2200, and 2300 for each country are configuration including, as an example of the user group 2100 of country A among users who have joined the foreign currency exchange system section 1000 and opened the online dedicated account, a user terminal 2110 in country A used by a user who has the online dedicated account opened in the foreign currency exchange system and needs to be exchanged for another country's currency and a plurality of country A non-related person terminals 2120 used by non-related persons not related to the exchange applicant who are selected by the exchange management computer 1310 and make a decision on whether to approve the exchange of the exchange requester when a exchange request is input to the user terminal 2110 of the country A.

Herein, the non-related person will be defined in more detail. In the present invention, the non-related person is a concept that transcends borders. If there is user a named a in country A and non-related persons are referred to as b, c, d . . . (omitted), the non-related person may belong to country A (however, if the configuration excludes the country, country A is excluded), or may be of a nationality other than country A.A person with a nationality other than Country A is not necessarily the non-related person. The reason is that if the person has international exchanges or is a famous person, there may be many acquaintances or related persons in other countries. In the description of FIG. 4, the user terminal and the non-related terminal may exist for each country, but the nationality of the user of the non-related terminal of each country is more likely to not be the nationality of the corresponding country. Thus, it is highly likely that the nationality of a user of non-related person terminal of country A is not country A.

A user using the foreign currency exchange system section 1000 opens an online dedicated account for each country in the account generation system 1200 in the state that user authentication is completed in the identity authentication system 1100, and then It is also possible to exchange into each country's currency using an online dedicated account for each country linked to existing financial account information.

The exchange management computer 1310 may store data of users associated with the foreign currency exchange system, such as exchange history information and exchange approval details, by utilizing a storage space for each user provided by the cloud computing system 3000 or storage space set in the user terminal.

The currency exchange management system 1300 sets and selects the number of non-related persons not related to the country and the currency exchange applicant who will participate in the decision-making related to the approval of the currency exchange application in the approval participant information management unit 1312, and the number of approved participants It may further include an artificial intelligence computer for performing setting and selection with artificial intelligence.

The exchange management system 1300 may further include an artificial intelligence computer for performing, in the approval participant information management unit 1312, selection of a country to participate in the decision-making related to the approval of the exchange application, setting and selection of the number of non-related persons not related to the exchange applicant, and setting and selection of the number of approval participants with artificial intelligence.

For example, a predetermined number of countries may be selected by including countries using the currency to be exchanged except for the country to which the user belongs, and a predetermined number of unrelated approved participants belonging to the selected countries may be selected. In this case, under the condition that the number of approval participants who are non-related person of the country of use of the exchanged currency (in the example above, the United States) becomes more than a predetermined ratio, It may be configured to process approval of the user's application for currency exchange.

Here, a ‘non-related person’ who has no relationship with the requester is a person who has no interest with the requester, and in principle, there are no communication details such as text messages, messages, calls, and no e-mail, SNS exchange, or financial transaction. In addition, when all people are connected through a network or Internet network, it is desirable to select a person who is not directly communicated or exchanged as a non-related person because they are separated by a certain stage (e.g., two stages) or more. The number of non-related persons can be initially set in the system for 100 or more people, and as the system is operated and data is accumulated, the artificial intelligence computer can automatically determine the number of non-related persons.

The exchange in the foreign currency exchange system of the present invention may be configured to receive approval under the conditions of N or more countries other than the country to which the requester belongs, including the country to which the currency is exchanged (United States for dollar exchange), K persons, the total number of approval participants as non-related persons who are not related to the requester, and P % or more of the total number of persons participating in the approval by persons from the country being exchanged (United States in the case of dollar conversion). Here, for example, the N value can be set initially by the system operator to 10 countries, the K value to 100 people, and the P value to 50%. The number of countries and countries participating in the approval of the currency exchange application, and the number of approved participants and approved participants in the selected country may be automatically selected and set by using various data related to the approval of the exchange application in the exchange management system or the artificial intelligence computer.

Therefore, the present invention may be configured in which the exchange requester requests online currency exchange using an online dedicated account, when there is no problem in the contents by checking whether the exchange amount is correct by non-related persons in countries randomly designated by the artificial intelligence computer, the exchange ledgers store, in a distributive manner, in the terminal of the exchange requester, the exchange management system, and the terminal of non-related persons, or storage space allocated to the cloud computing system, and transmitting an exchange completion message to the user terminal of the exchange requester.

In this case, the exchange ledger may be stored, in a distributive manner, in the information of all approved participants, or in consideration of the load and speed of the system, in the storage space of the non-related terminals of the pre-set number of approved participants or the number automatically set by the artificial intelligence computer, or in the storage of the cloud computing system granted to the approval participants.

Approval of the exchange application by the approval participants is performed through verification of the validity of the exchange amount by applying the ‘basic exchange rate’ at the time of the exchange application, and by using the terminal of the approval participants or a related program of the cloud computing system. It may be configured to be finally approved when the exchange applicant checks the basic exchange rate of the currency at the time of the exchange application by the exchange requester, compares the verification results f the validity of the approval participants and matches them.

Table 2 shows an example of a case in which a user of country A using the exchange management system 1300 in the foreign currency exchange system of the present invention exchanges the user's currency with another country's currency.

TABLE 2

| Account information of | | Exchange application | Exchange amount of | |
|---|---|---|---|---|
| Country A financial | | amount by country | dedicated account by | |
| institute | | and exchange rate | country | Country |
| 100,000,000 | Currency of | 17,000(USD), 1,250:1 | 21,250,000 | US |
| | country A | | USD$17,000.00 | |
| | (e.g., Korean | 15,000(EUR), 1300:1 | 19,500,000 | EP |
| | currency | | EUR15,000.00 | |
| | KRW) | 5,000(CNY), 175:1 | 875,000 | CN |
| | | | CNY5,000 | |

The system of the present invention is an automatic exchange system based on trust between members using a book sharing method, and since it has the advantage that anyone can exchange into a specific country's currency without paying an exchange fee, it can be operated without a separate compensation. However, in order to facilitate the operation of the system of the present invention, points may be granted or certain benefits may be provided to persons participating in the approval of the exchange application in proportion to the number of approvals or the amount of approval.

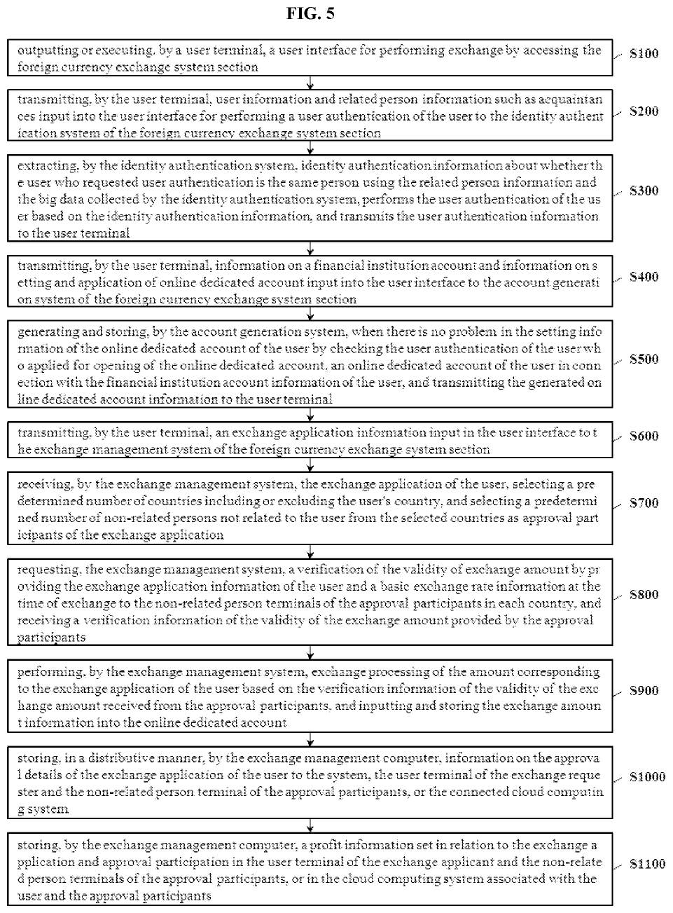

FIG. 5 is a flowchart illustrating an exemplary embodiment of a method for foreign currency exchange of the present invention.

As illustrated in FIG. 5, the method for foreign currency exchange of the present invention, comprising: outputting or executing, by a user terminal, a user interface for performing exchange by accessing the foreign currency exchange system section (S100); transmitting, by the user terminal, user information and related person information such as acquaintances input into the user interface for performing a user authentication of the user to the identity authentication system of the foreign currency exchange system section (S200); extracting, by the identity authentication system, identity authentication information about whether the user who requested user authentication is the same person using the related person information and the big data collected by the identity authentication system, performs the user authentication of the user based on the identity authentication information, and transmits the user authentication information to the user terminal (S300); transmitting, by the user terminal, information on a financial institution account and information on setting and application of online dedicated account input into the user interface to the account generation system of the foreign currency exchange system section (S400); generating and storing, by the account generation system, when there is no problem in the setting information of the online dedicated account of the user by checking the user authentication of the user who applied for opening of the online dedicated account, an online dedicated account of the user in connection with the financial institution account information of the user, and transmitting the generated online dedicated account information to the user terminal (S500); transmitting, by the user terminal, an exchange application information input in the user interface to the exchange management system of the foreign currency exchange system section (S600); receiving, by the exchange management system, the exchange application of the user, selecting a predetermined number of countries including or excluding the user's country, and selecting a predetermined number of non-related persons not related to the user from the selected countries as approval participants of the exchange application (S700); requesting, the exchange management system, a verification of the validity of exchange amount by providing the exchange application information of the user and a basic exchange rate information at the time of exchange to the non-related person terminals of the approval participants in each country, and receiving a verification information of the validity of the exchange amount provided by the approval participants (S800); performing, by the exchange management system, exchange processing of the amount corresponding to the exchange application of the user based on the verification information of the validity of the exchange amount received from the approval participants, and inputting and storing the exchange amount information into the online dedicated account (S900); storing, in a distributive manner, by the exchange management computer, information on the approval details of the exchange application of the user to the system, the user terminal of the exchange requester and the non-related person terminal of the approval participants, or the connected cloud computing system (S1000); and storing, by the exchange management computer, a profit information set in relation to the exchange application and approval participation in the user terminal of the exchange applicant and the non-related person terminals of the approval participants, or in the cloud computing system associated with the user and the approval participants (S1100).

The embodiments of the present invention described above are only some of the various embodiments. It is natural that various embodiments included in the technical idea of performing the user authentication for the opening and exchange of an online dedicated account based on the consistency between the data analyzed from the information of related persons including acquaintances, etc. and the related data collected by itself, performing process of the exchange based on opening an online dedicated account for each country of the user whose user verification has been completed, an exchange application using the opened online dedicated account for each country of the user, and approval of exchange through verification of the validation of the exchange application by non-related persons selected in selected countries, and providing certain benefits to approval participants participating in exchange approval are included in the protection scope of the present invention.

### INDUSTRIAL APPLICABILITY

In the present invention, when exchanging a specific currency into another country's currency, it is possible to easily exchange through online.

What is claimed:

1. A computer for exchange management that receives an exchange application of user and exchanges the user's currency into another country's currency, comprising:
at least one hardware processor and a memory storing a program for performing currency exchange that causes the computer to:
receive, by the at least one hardware processor of the computer, an exchange application entered into an online dedicated account for each country by a user who wants to exchange the user's currency into another country's currency;
select, by the at least one hardware processor of the computer, a predetermined number of countries to participate in whether or not to approve the exchange application of the user; and
perform, by the at least one hardware processor of the computer, exchange of the user's currency into the currency of another country based on verification of the validity of the exchange application by the approval participants made up of a predetermined number of non-related persons selected in the selected countries.

2. The computer for exchange management of claim 1, wherein the verification of the validity of the exchange application:
extracts information of non-related persons not related to the user in the selected countries,
selects a predetermined number of non-related persons among the extracted non-related persons as a non-related person approval participant to participate in a decision on whether to approve the exchange application, and
performs based on the decision on whether to approve the exchange application provided by the selected non-related approval participants.

3. The computer for exchange management of claim 2, wherein the exchange management computer stores, in a distributive manner, approval details of the exchange application by non-related person approval participants, which is information on decision-making on whether to approve of the exchange to terminals of the user and non-related persons.

4. A system for foreign currency exchange system, comprising:
an identity authentication computer which:
receives user identification information provided by at least one related person including an acquaintance related to the user,
verifies identity of the user by determining the consistency between data representing the relationship between acquaintances secured through the analysis of communication details between the user and the related persons who verified the user's identity and data representing the relationship between the acquaintances collected and held by the system, and
performs the user authentication of the user based on the information on the identity confirmation of the user;
an account generation management computer which generates and stores online dedicated accounts in connection with the user's financial information when the user who have completed user authentication on the identity verification computer applies for opening an online dedicated account for each country; and
an exchange management computer which, when the user applies for exchange using the online dedicated account for each country opened,
selects a predetermined number of countries,
selects a predetermined number of non-related persons not related to the user from the selected countries, and
receives the result of verification as to whether the exchange amount provided by the selected non-related persons is correct, and performs exchange processing.

5. The system for foreign currency exchange system of claim 4, wherein the result of verification as to whether the exchange amount by the non-related persons is correct is a decision on whether to approve the exchange application provided by a predetermined number of non-related approval participants who will participate in the decision-making on whether to approve the exchange application selected from among the non-related persons.

6. The system for foreign currency exchange system of claim 5, wherein the exchange management computer stores, in a distributive manner, approval details of the exchange application of non-related person approval participants which is information on decision-making on whether to approve the exchange, in the terminals of the user and non-related persons.

7. A method for foreign currency exchange, comprising:
receiving, by an exchange management computer, an exchange application of user's currency into another country's currency input by the user into an online dedicated account for each country; and
selecting, by the exchange management computer, a predetermined number of country, and performing the exchange of the user's currency into another country's currency based on verification of the validity of the exchange application provided by a predetermined number of non-related person approval participant selected in the selected countries.

8. The method for foreign currency exchange of claim 7, wherein the verification of the validity of the exchange application:
extracts information of non-related persons not related to the user in the selected countries,
selects a predetermined number of non-related persons among the extracted non-related persons as a non-related person approval participant to participate in a decision on whether to approve the exchange application, and
performs based on the decision on whether to approve the exchange application provided by the selected non-related approval participants.

9. The method for foreign currency exchange of claim 7, further comprising storing, in a distributive manner, by the exchange management computer, approval details of the exchange application by non-related person approval participants, which is information on decision-making on whether to approve of the exchange to terminals of the user and non-related persons.
